(19) United States
(12) Patent Application Publication
(10) Pub. No.: US 2007/0022901 A1
(43) Pub. Date: Feb. 1, 2007

(54) Metallic ink, and use thereof for improving prints

(75) Inventors: Ulrich Kurze, Busenberg (DE); Peter Schlichting, Mannheim (DE); Thomas Leuschner, Boeblingen (DE); Uwe Baz, Bietigheim-Bissingen (DE); Burkhard Krietsch, Dieburg (DE)

Correspondence Address: CONNOLLY BOVE LODGE & HUTZ, LLP, P O BOX 2207, WILMINGTON, DE, 19899, US

(73) Assignees: XSYS Print Solutions Deutschland GmbH, Stuttgart (DE); Merck Patent GmbH, Darmstadt (DE)

(21) Appl. No.: 10/557,259

(22) PCT Filed: May 10, 2004
(86) PCT No.: PCT/EP04/04961

§ 371 Date: Nov. 17, 2005

(30) Foreign Application Priority Data
May 21, 2003 (DE) 103 23 374.1

(51) Int. Cl. C09D 11/00; C03C 17/00

(52) U.S. Cl. 106/31.6; 106/31.9; 523/160

(57) ABSTRACT

Liquid or pasty metallic printing inks which contain a mixture of at least one metal effect pigment and at least one partly optically transparent effect pigment and are used for finishing prints.

The present invention relates to liquid or pasty metallic printing inks which contain a mixture of at least one metal effect pigment and at least one partly optically transparent effect pigment. It furthermore relates to the use thereof for finishing prints and a process for finishing prints.

In mechanical printing processes, such as offset printing, letterpress printing, flexographic printing, gravure printing or screen printing, the printing ink is transferred to the print medium by bringing a printing plate provided with printing ink into contact with said print medium. Printing inks for these printing processes usually comprise solvent, colorant, binder and, if required, various additives. Printing inks for mechanical printing processes include pasty printing inks having a high viscosity and high-boiling solvents, in particular for offset and letterpress printing, and liquid printing inks having a comparatively low viscosity and low-boiling solvents, in particular for flexographic, gravure or screen printing. Further details are disclosed, for example, in Printing Inks—Ullmann's Encyclopedia of Industrial Chemistry, Sixth Edition, 1999 Electronic Release.

A known technique comprises finishing prints by means of gold bronzes, silver bronzes or copper bronzes. This technique is used, for example, in the printing of high-quality packagings, brochures or labels. In the conventional bronzing, the label or the packaging is first prepared in the usual way, for example by means of offset or flexographic multicolor printing. In a further operation, a special underprinting ink which has a very strong adhesive effect is then applied to the areas of the print which are subsequently to have metallic effects. In a bronzing machine, a bronze powder, for example comprising gold bronze, silver bronze or copper bronze, or another effect pigment is then applied, the powder remaining adhering to the parts printed with the underprinting ink and imparting the typical metallic effect to the printed article. The bronzing machine is divided into a bronzing part and into a dust removal part. In the bronzing part of this machine, the bronze powder is dusted on by means of plush-covered application rollers and bronzing is then effected by means of the wipers, and excess bronze powder is removed again by the downstream belts. Finally, the bronzed sheets travel into a stacker delivery. The entire print may still have to be overcoated in a further operation in order to increase the abrasion resistance of the bronze layer. Further details of conventional bronzing are described, for example, in Offsetdruck by Wolfgang Walenski, Polygraph Verlag Frankfurt am Main 1991, Chapter 29, Gold und Silberdruck, page 204 et seq. or Römpp Lacke und Druckfarben, Thieme Verlag 1998, Metalldruckfarben, page 376 et seq.

However, the conventional bronzing is very expensive. At least 3 production steps are required. Since furthermore not every printer has the appropriate means for bronzing, there may be additional transport costs for transport to a contract finisher who performs the bronzing and transport back. Furthermore, the handling of bronze powders gives rise to considerable dust pollution, and extraction systems are therefore required. The conventional bronzing is accordingly expensive and very time-consuming.

Conventional bronzing gives metallic layers of good quality which have glitter effects independently of the angle of view. However, the edges of the motifs are blurred so that particularly fine motifs cannot be produced in satisfactory quality by means of conventional bronzing.

Moreover, in conventional bronzing, the printer has to cope with a number of further problems. Thus, the sheets to be bronzed can frequently be only poorly and nonuniformly dusted, or the sheets tear or bend in the bronzing machine or the corners turn over. Further problems in practice include poor adhesion of the bronze, problems with the drying of the underprinting ink, oxidation and corrosion phenomena and poor removal of the bronze powder.

As an alternative to conventional bronzing, it is known that it is possible to use metallic printing inks which contain metal effect pigments and which can be printed substantially in the same way as conventional printing inks. Details are disclosed, for example, in Römpps-Lexikon, Lacke und Druckfarben, Thieme-Verlag, Stuttgart, 1998. For example, they may be flexographic printing inks. Such metallic flexographic printing inks usually contain up to 40% by weight of metal effect pigments. Letterpress or offset printing inks have a lower pigment content and usually contain up to 25% by weight of metal effect pigments. However, the known printing inks give technically poorer metallic layers. While in conventional bronzing the metallic glitter effect is substantially independent of the angle of view, this effect occurs only at certain angles on printing with metallic printing inks, whereas no glitter is observable at other angles.

In spite of this clear technical disadvantage, nowadays, for cost reasons, many orders are not bronzed but are printed using metallic printing inks. The reductions in quality compared with bronzing are consciously accepted because the market will not pay the additional price of a conventional bronzing. U.S. Pat. No. 4,221,593 discloses a gold-colored printing ink which may contain up to 52 to 60% by weight of metal effect pigment. However, a very special organic binder system comprising phenol and xylene resins and gel-forming components, such as aluminum alcoholates or chelates, amines and wood oil or petroleum as organic solvents is required. Aqueous formulations are not described. However, such a special binder system permits only a very limited range of use. No adaptation to different printing techniques is possible; in particular, the printing ink disclosed cannot be printed by means of the flexographic printing technique.

EP-A 803 552 discloses pearl luster pigment formulations which are provided for the production of printing inks having a pearl luster effect. The pearl luster pigments can also be mixed with amounts of up to 20% by weight, based on the pearl luster pigment, of metal effect pigments. The bronzing of prints is not disclosed.

WO 98/38253 discloses pigment preparations comprising pearl luster or metal effect pigments and the use thereof for the production of printing inks. The document also discloses pigment preparations in which pearl luster and metal effect pigments are mixed with one another in a ratio of from 10:1 to 1:1. Details for the formulation of printing inks and the use thereof for bronzing are not disclosed.

WO 98/13426 and WO 98/53010 disclose special pearl luster pigments and the use thereof inter alia for the production of printing inks. The documents mention the possibility of mixing the pearl luster pigments with other pigments, for example including metal effect pigments. Details for the formulation of printing inks and the use thereof for bronzing are not disclosed.

It is an object of the present invention to provide metallic printing inks which can be printed in a simple manner in the same way as a conventional printing ink and with which an effect comparable with conventional bronzing, i.e. glittering substantially independent of the angle of view, can nevertheless be achieved. They should be liquid printing inks, for example printable by means of the gravure, flexographic or screen printing technique, or pasty printing inks, for example printable by means of the offset or letterpress printing technique. The metallic printing inks may in particular also be aqueous flexographic, gravure or screen printing inks. It is a further object of the present invention to improve the crispness of the edge regions in comparison with conventional bronzing, in order to be able to reproduce even fine motifs with high quality.

We have found that this object is achieved by liquid metallic printing inks for flexographic, gravure or screen printing, which comprise at least one solvent or solvent mixture, at least one polymeric binder, at least two different effect pigments and optionally further additives, the effect pigments comprising from 20 to 60% by weight of at least one metal effect pigment and from 20 to 60% by weight of at least one partly optically transparent effect pigment, with the proviso that the total amount of all effect pigments in the printing ink is from 40 to 80% by weight, the amounts in each case being based on the sum of all components of the printing ink.

In a further aspect of the present invention, pasty metallic printing inks for offset or letterpress printing, which comprise at least one solvent or solvent mixture, at least one polymeric binder, at least two different effect pigments and optionally further additives, have been found, the effect pigments comprising from 10 to 40% by weight of at least one metal effect pigment and from 8 to 30% by weight of at least one partly optically transparent effect pigment, with the proviso that the total amount of all effect pigments in the printing ink is from 18 to 55% by weight, the amounts in each case being based on the sum of all components of the printing ink.

In a further aspect of the present invention, the use of said metallic printing ink for finishing printed substrates and a process for finishing prints were found.

Surprisingly, it has been found that, by the novel combination of metal effect pigments with partly optically transparent effect pigments and a degree of pigmentation exceeding the usual level, printing inks are obtained by means of which it is possible to print metallic elements whose quality is equivalent to the quality achievable by means of conventional bronzing. Moreover, it is even possible to print substantially crisper edges. What was surprising for a person skilled in the art was on the one hand the fact that such high degrees of pigmentation were achievable at all without the printing properties of the printing ink suffering thereby. Furthermore, the simplicity of the solution was also particularly surprising. The quality improvement is achieved in the case of flexographic, gravure, offset, screen or letterpress printing inks.

Regarding the present invention, the following may be stated specifically:

The novel metallic printing inks may be liquid printing inks, for example flexographic, gravure or screen printing inks, or pasty printing inks, for example for offset or letterpress printing. Apart from the effect pigments and optionally additional colorants, they comprise at least one solvent or one solvent mixture, at least one polymeric binder and optionally further additives. They may be printing inks which dry by absorption and/or evaporation of the solvent, oxidatively drying inks or inks drying by further mechanisms or UV-curable inks. The terms pasty printing inks and liquid printing inks are known to a person skilled in the art. Liquid printing inks contain comparatively low-viscosity and low-boiling solvents, whereas pasty printing inks contain comparatively high-viscosity and high-boiling solvents. Further details of the classification of printing inks are disclosed, for example, in Römpps-Lexikon, Lacke und Druckfarben, Thieme-Verlag, Stuttgart, 1998, page 157 et seq. (in particular pages 159/160, tables 4 and 5 and the figure on page 160).

The two types of printing ink are based on the same inventive principle, i.e. a mixture of two effect pigments of different type in combination with high pigmenting.

The novel printing inks comprise at least two different effect pigments. The term effect pigments is defined, for example, in Römpps-Lexikon, Lacke und Druckfarben, Thieme-Verlag, Stuttgart, 1998, page 176. It is understood as meaning pigments whose optical effect is preferably based on the reflection of light.

The novel printing inks comprise at least one metal effect pigment. Metal effect pigments are known. Metal effect pigments are lamellar metal pigments which substantially are not optically transparent but reflect the incident light virtually completely. Accordingly, the metal effect pigments used are opaque.

The metal effect pigments may consist, for example, of aluminum, copper, zinc, tin or their alloys. They may be, for example, gold bronzes comprising copper-zinc alloys. The hue can be controlled in a known manner by the composition of the alloy. They may also be modified pigments. The gold bronzes can, for example, be superficially oxidized in a specific manner (i.e. fire-colored bronzes). The thin oxide layers on the surface of the metal give rise to interference effects through which particularly attractive optical effects can be achieved. The gold bronzes may also be treated, for example by coating with SiO₂, for better stability, in particular in aqueous systems. Silver effects can be obtained by using aluminum pigments, also referred to as silver bronzes. For use in aqueous systems, silver bronzes can be passivated and/or treated with inhibitors. Aluminum lamellae can also be superficially coated once or several times, for example with thin metal oxide layers, for example comprising iron oxides. Further optical effects can be achieved by interference effects in the thin metal oxide layers. Further details on metal effect pigments are disclosed, for example, in Metal Effect Pigments in Ullmann's Encyclopedia of Industrial Chemistry, 6^{th} Edition, Electronic Release, Wiley-VCH, Weinheim 2000. Metal effect pigments are commercially available, for example from Eckart-Werke, Fürth.

The particle size of the metal effect pigments used is determined by a person skilled in the art according to the desired properties and the desired use of the printing ink. As a rule, the mean particle size (mean diameter of the lamellae) should be from about 2 to about 20 μm, without there being any intention thereby to restrict the invention to this range. A mean particle size of from about 7 to about 15 μm has proven particularly useful.

Mixtures of two or more different metal effect pigments can of course also be used.

In the case of liquid metallic printing inks, according to the invention from 20 to 60% by weight, based on the sum of all components of the liquid printing ink, of metal effect pigments are used. Preferably from 25 to 45, particularly preferably from 30 to 40, for example 35, % by weight are used.

In the case of pasty metallic printing inks, according to the invention from 10 to 40% by weight, based on the sum of all components of the pasty printing ink, of metal effect pigments are used. Preferably from 10 to 30, particularly preferably from 10 to 15, % by weight are used.

The novel printing inks furthermore comprise at least one partly optically transparent effect pigment. Mixtures of a plurality of different partly optically transparent effect pigments can of course also be used.

In a preferred embodiment of the invention, the partly optically transparent effect pigments are pearl luster pigments. Modern pearl luster pigments consist of transparent or semitransparent lamellar substrates, for example mica, synthetic mica, talc, kaolin, glass or other silicate materials having a high refractive index, which are coated with colorless or colored metal oxides, for example Fe₂O₃, Fe₃O₄, Cr₂O₃, TiO₂, SnO₂, ZnO, CuO or NiO, and other metal oxides. One uniform layer or a plurality of successive layers may be present. Depending on the type of oxide and on the thickness and number of layers, different effects can be achieved. Gold-colored pigments can be obtained, for example, by means of iron oxide layers, and silver-colored pigments by means of titanium dioxide layers. Pearl luster pigments based on mica and iron oxide layers and/or titanium dioxide layers are preferred.

Further details on pearl luster pigments are disclosed, for example, in Nacreous and Interference Pigments in Ullmann's Encyclopedia of Industrial Chemistry, 6^{th} Edition, Electronic Release, Wiley-VCH, Weinheim 2000 or WO 98/13426, WO 98/53010 or DE 101 24 657.

The particle size of the partly optically transparent effect pigments used is determined by a person skilled in the art according to the desired properties and the intended use of the printing ink. Industrial products always have a certain particle size distribution. As a rule, the minimum size (diameter of the lamellae) is 1 μm, while a diameter of not more than 500 μm generally should not be exceeded. A size of from 10 to 120 μm for flexographic, gravure, letterpress and screen printing applications and of from 5 to 25 μm for offset applications has proven particularly useful.

The pigments can also be treated with further components, for example with dispersants.

Pearl luster pigments are commercially available, for example as Iriodin®/Afflair® (from Merck KGaA, Darmstadt), or Phoenix® pearl luster pigments (from Eckart-Werke Fürth).

However, other types of partly optically transparent effect pigments may also be used. Particular examples of these are effect pigments based on liquid crystals, for example Helicon® (from Wacker) or Paliochrom (from BASF).

In the case of the liquid metallic printing inks, the amount of the partly optically transparent effect pigments is, according to the invention, from 20 to 60% by weight, based on the sum of all components of the printing ink. Preferably from 25 to 45, particularly preferably from 25 to 35, for example 30, % by weight are used.

In the case of the pasty metallic printing inks, the amount of the partly optically transparent effect pigments is, according to the invention, from 8 to 30% by weight, based on the sum of all components of the printing ink. Preferably from 10 to 25, particularly preferably from 15 to 20, % by weight are used.

In the case of the liquid printing inks, the content of the metal effect pigments and of the partly optically transparent effect pigments together is, according to the invention, from 40 to 80, preferably from 50 to 75, particularly preferably from 55 to 70, for example 65, % by weight, based in each case on the sum of all components of the metallic printing ink.

In the case of the pasty printing inks, the content of the metal effect pigments and of the partly optically transparent effect pigments together is from 18 to 55, preferably from 20 to 50, particularly preferably from 25 to 40, for example 30, % by weight, based in each case on the sum of all components of the metallic printing ink.

A person skilled in the art makes a suitable choice from the metal effect pigments and the partly optically transparent effect pigments according to the desired optical effect. For example, typical gold or silver colors can be formulated. For gold hues, the combination of one or more gold bronzes with a likewise gold-colored pearl luster pigment (e.g. Iriodin® 305 Solargold) has proven useful. For precise control of the glitter effects, for example, silver bronzes may also be admixed. When other pearl luster interference pigments are used, a very wide range of color flop or changing effects can be obtained.

In addition to the at least two effect pigments, the novel printing inks can moreover optionally also comprise further colorants or colored pigments. Further optical effects can be achieved thereby.

By combination with additional colorants, it is also possible to obtain gold colors without the use of gold bronzes by using a silver bronze, mixing it with a yellow or orange colorant and, as described above, adding a gold-colored pearl luster pigment (i.e. heavy metal-free gold).

Solvents and solvent mixtures serve, inter alia, for dissolving the binder, but also for establishing important performance characteristics of the printing inks, for example the viscosity or the drying rate. The type of solvent depends on the respective intended use of the printing ink and is chosen accordingly by a person skilled in the art.

Solvents and components of solvent mixtures for pasty printing inks comprise in particular high-boiling mineral oils or vegetable oils, for example soybean oil. The boiling point is as a rule not less than 230° C. but may also be more than 300° C.

Solvents used for liquid printing inks, such as flexographic and gravure printing inks, comprise in particular low-boiling solvents. The boiling point is as a rule not more than 140° C. Screen printing inks are formulated similarly to flexographic or gravure printing inks but are merely made slightly more viscous and usually have solvents with slightly higher boiling points. Examples of suitable solvents for liquid printing inks include ethanol, 1-propanol and 2-propanol, substituted alcohols, for example ethoxypropanol, and esters, for example ethyl acetate, isopropyl acetate, n-propyl acetate and n-butyl acetate. It is of course also possible to use mixtures of different solvents. For example, this may be a mixture of ethanol and esters, such as ethyl acetate or propyl acetate. For printing with flexographic printing plates, it is as a rule advisable for the proportion of the esters in the total solvent not to exceed about 20-25% by weight. Water or a predominantly aqueous solvent mixture should also preferably be used as solvents for liquid printing inks.

Depending on the type of the printing ink, usually from 10 to 55% by weight, based on the sum of all components, of solvent are used.

Radiation-curable printing inks generally contain not the abovementioned solvents but reactive diluents. Reactive diluents typically perform a dual function. On the one hand, they serve for crosslinking or curing of the printing ink; on the other hand, they serve, like conventional solvents, for establishing the viscosity. Examples include butyl acrylate, 2-ethylhexyl acrylate and in particular polyfunctional acrylates, such as butanediol 1,4-di(meth)acrylate, hexanediol 1,6-di(meth)acrylate or trimethylolpropane tri(meth)acrylate.

In principle, the binders customary for liquid printing inks and pasty printing inks can be used as binders for the novel metallic printing inks. A person skilled in the art makes a suitable choice according to the desired intended use and the desired properties. Examples of suitable binders include polyesters, polyamides, PVC copolymers, aliphatic and aromatic ketone resins, melamine/urea resins, melamine/formaldehyde resins, maleates, rosin derivatives, casein and casein derivatives, ethylcellulose, nitrocellulose or aromatic or aliphatic polyurethanes. Polymers or copolymers of vinyl acetate, vinyl alcohol, acrylates, methacrylates, vinylpyrrolidone or vinyl acetals may also be used. Hyperbranched polymers having functional groups, for example hyperbranched polyurethanes, polyureas or polyesteramides, can be particularly advantageously used, as disclosed in WO 02/36695 and WO 02/36697. It is of course also possible to use mixtures of different polymeric binders, provided that the binders chosen do not have any undesired properties in combination with one another. The amount of all binders is usually 5-20% by weight, based on the sum of all components of the printing ink.

Binders particularly preferred for liquid printing inks include, for example, nitrocellulose, ethylcellulose, hydroxyethylcellulose and aliphatic and aromatic polyurethanes and polyureas, in particular hyperbranched polyurethanes and polyureas and mixtures thereof.

Particularly suitable binders for water-dilutable metallic printing inks are copolymers based on (meth)acrylic acid and/or esters thereof with styrene. Such binders are commercially available as solutions or dispersions for use in printing inks, for example under the name Zinpol® (from Worlee). Further examples include aromatic and aliphatic aqueous polyurethanes, polyesters and aqueous polyamides.

Binders preferred for pasty printing inks include, for example, rosins or modified rosins. Examples of modified rosins include rosins completely or partly esterified with polyols, for example glycerol or pentaerythritol.

Radiation-curable printing inks comprise binders which comprise crosslinkable groups, for example olefinic groups, vinyl ether groups or epoxide groups.

The novel metallic printing inks may furthermore comprise one or more assistants or additives. Examples of additives and assistants are fillers, such as calcium carbonate, hydrated alumina or aluminum silicate or magnesium silicate. Waxes increase the abrasion resistance and serve for increasing the slip. Examples are in particular polyethylene waxes, oxidized polyethylene waxes, petroleum waxes and ceresin waxes. Fatty acid amides can be used for increasing the surface smoothness. Plasticizers serve for increasing the resilience of the dried film. For radiation-curable printing inks, at least one photoinitiator or one photoinitiator system is furthermore used as an additive. Dispersants may be used for dispersing the effect pigments. By means of fatty acids, it is possible to achieve flotation of the effect pigments in the printed layer so that the pigments accumulate at the upper boundary of the print layer. Improved metallic effects can advantageously be achieved thereby. Furthermore, antisedimentation agents may also be added. Such additives prevent the sedimentation of the effect pigments. Examples include silica, cellulose derivatives and waxes. For formulating low-viscosity metallic printing inks, such as flexographic, gravure or screen printing inks, the addition of antisedimentation agents is generally advisable, although not always absolutely essential. The total amount of all additives and assistants should usually not exceed 20% by weight, based on the sum of all components of the printing ink, and is preferably 0.1-10% by weight.

The preparation of the novel metallic printing inks can be carried out in a manner known in principle, by thorough mixing or dispersing of the components in conventional apparatuses, for example dissolvers or stirred apparatuses. When dissolvers are used, a person skilled in the art will ensure that the energy introduced is not too high, in order to avoid damaging the metal effect pigments. Conversely, it must of course be sufficiently high to permit proper dispersing of the pigments. If, in addition to the effect pigments, conventional colored pigments are also used, it may be advisable to predisperse them in a portion or in the total amount of the solvent, binder and any assistants of the metallic printing ink and not to add the effect pigments until later on. In this way, particularly good dispersing of the additional pigments is achieved without damaging the effect pigments by excessively strong dispersing. Instead of the pigments, predispersed pigment concentrates may also be added. In a very particularly elegant procedure, it is also possible here to use a commercial printing ink in small amounts, provided that the added printing ink is compatible with the formulation of the metallic printing ink and does not adversely affect the properties thereof.

The optimum dispersing conditions can be determined by a person skilled in the art for the respective formulation, if required, by a few routine experiments.

Particularly preferred metallic printing inks contain silver bronzes and/or gold bronzes as metal effect pigments. Flexographic printing inks are preferably formulated as water-based inks.

The novel metallic printing inks are suitable in principle for printing on a very wide range of substrates, for example paper, cardboard boxes, board, corrugated board, plastics films or metal foils, composite materials, metal sheets, textiles, glass or porcelain. Of course, not all types of printing inks and formulations are equally suitable for all substrates. A person skilled in the art knows which types of printing processes and components of printing inks are particularly suitable for which substrates.

The novel metallic printing inks can be used in particular for finishing printed substrates. Here, a monochrome or multicolor print is first produced, for example by means of offset, gravure or flexographic printing. The printed substrate is then printed on using the novel metallic printing ink according to the desired motifs. Examples include labels for wine, beer or cognac bottles which are printed with additional gold or silver motifs, packagings, for example for cigarettes, cosmetics or perfume, and also, for example, wallpapers, gift wrapping or decorative papers, documents or brochures. The ink can of course also be printed over a solid area. It is also possible to print on textiles or porcelain.

Printing with the novel metallic printing ink can be effected inline or offline. A preferred process for finishing prints employs a one-color or multicolor printing press which is equipped with an additional printing unit for printing the metallic printing ink. By means of the printing press, a motif is printed on the substrate, and metallic motifs are printed thereon by means of the additional printing unit and the novel metallic printing ink. Printing with the metallic motif can be effected as preprinting before the printing of the normal motif or thereafter as an overprint. As a rule, it is advisable to homogenize the metallic printing ink once again before use, for example by stirring up.

The one-color or multicolor printing press may be, for example, a flexographic, gravure or offset printing press or a combination printing press. It is preferably an offset printing press, in particular a sheet-feed offset press. In a further preferred embodiment, the additional printing unit is a flexographic or gravure printing unit.

The metallic layer obtained by the novel process is as a rule substantially more stable to abrasion than in the case of the conventional bronzing, so that the application of a protective layer, for example by overcoating, is not necessary. However, the prints can of course also be provided with one or more protective layers after the finishing with metallic printing ink.

However, special offline coaters or varnish finishing machines may also be used for printing or applying the novel metallic printing ink. It is also suitable for use in paper coating or by means of air brushes. The novel printing ink can also be printed by means of pad printing, for example for printing on porcelain or ceramic. For printing on textiles, the screen printing technique is particularly suitable.

By means of the novel liquid or pasty metallic printing inks and the novel process, it is possible to achieve effects which were obtainable to date only by means of conventional bronzing. The production of high-quality prints finished by means of metallic effects is thus possible at substantially lower costs. Furthermore, the printed layers have a metallic glitter substantially independent of angle. The edge regions of the printed motifs are even substantially crisper than in the case of conventional bronzing, so that it is even possible to produce fine motifs having a higher resolution than to date.

The examples which follow illustrate the invention:

Experiment 1

Aqueous metallic printing ink for flexographic printing (gold effect)

The following components were used for novel printing ink:

| | Amount |
|---|---|
| Components | [% by weight] |
| Aqueous brass-based gold bronze paste, average | 123 |
| particle size 10 μm (solids 80% by weight of | |
| bronze, 20% by weight of water) (Gold bronze | |
| Aquador ® rich pale gold, WP 4120/80, from | |
| Schlenk) | |
| Gold-colored mica-based pearl luster pigment, | 30 |
| particle size 10-60 μm (Iriodin ® Pearlets, | |
| Solar Gold W, from Merck KgaA) | |
| Binder | 26 |
| Acrylate/styrene dispersion, solids 35% by weight, | |
| water content 65% by weight (Zinpol ® 146, | |
| from Worl\dot{e}e) | |
| Water | 6.5 |
| Assistants | |
| PE wax emulsion, 40% solids, 60% water | 3 |
| (Lubaprint VP 499, from Bader) | |
| Antifoam based on silicone oil | 0.5 |
| (Tego Foamex ® 3062, from Degussa) | |
| Total | 100 |

Experimental procedure: The binder, together with the water and the assistants (waxes, antifoam) is introduced into a suitable container and homogenized for 5 minutes. Thereafter, the bronze paste is added and the batch is stirred for a further 25 minutes. Finally, the pearl luster pigment is added and stirring is continued for a further 30 minutes. If the viscosity is too high, it can be corrected with water. Before printing, the ink is stirred for at least 5 minutes for homogenization.

Experiment 2

Aqueous metallic printing ink for flexographic printing (silver effect)

The following components were used for novel printing ink:

| | Amount |
|---|---|
| Components | [% by weight] |
| Aqueous silver-colored aluminum-based metal | 25 |
| effect pigment paste, average particle | |
| size 8-12 μm, solids: 65%, 35% of water | |
| (Aluminum paste Hydroxal W 2020, from Eckart,) | |
| Silver-colored mica-based pearl luster pigment, | 25 |
| particle size 10-60 μm (Iriodin ® Pearlets 103, | |
| Sterling White W, from Merck KgaA) | |
| Binder: | 30 |
| Acrylate/styrene dispersion (solids 35% | |
| by weight, water content 65% by weight) | |
| (Zinpol ® 146, from Worl\dot{e}e) | |
| Water | 14.5 |
| Assistants | |
| PE wax emulsion, 40% of solids, 60% of water | 3 |
| (Lubaprint ® VP 499, from Bader) | |
| Antifoam based on silicone oil | 0.5 |
| (Tego Foamex ® 3062, from Degussa) | |
| Thickener based on an aqueous polyurethane | 2 |
| (solids 75%, water 25%) | |
| (Borchigel ® L 75 N, from Bayer AG) | |
| Total | 100 |

Experimental procedure: The binder, together with the water and the assistants (waxes, antifoam, thickener) is introduced into a suitable container and homogenized for 5 minutes. Thereafter, the aluminum paste is added and the batch is stirred for a further 25 minutes. Finally, the pearl luster pigment is added and stirring is continued for a further 30 minutes. If the viscosity is too high, it can be corrected with water. Before printing, the ink is stirred for at least 5 minutes for homogenization.

Experiment 3

Metallic printing ink comprising organic solvents for gravure or flexographic printing (gold effect)

The following components were used for novel printing ink:

| | Amount |
|---|---|
| Components | [% by weight] |
| Brass-based gold bronze powder, average particle | 25 |
| size 7-9 μm (gold bronze Resist Rotoflex ®, | |
| rich pale gold, from Eckart) | |
| Gold-colored mica-based pearl luster pigment, | 25 |
| particle size 10-60 μm (Iriodin ® Pearlets, | |
| Solar Gold S, from Merck KgaA) | |
| Binder | 27 |
| Polyvinyl butyral and aldehyde resin | |
| Solvents: | 20 |
| ethanol + ethyl acetate | |
| Assistants | |
| PE wax emulsion, 40% of solids, 60% of ethanol | 3 |
| (Lubaprint 654D, from Bader) | |
| Total | 100 |

Experimental procedure: The binder in the ethanol/ethyl acetate mixture and the wax emulsion is introduced into a suitable container and homogenized for 5 minutes. Thereafter, the gold bronze powder and then the pearl luster pigment are added in portions and the batch is stirred for a further 30 minutes. If the viscosity is too high, it can be corrected with ethanol or ethyl acetate. Before printing, the ink is stirred for at least 5 minutes for homogenization.

Experiment 4

Metallic printing ink comprising organic solvents for gravure or flexographic printing (silver effect)

The following components were used for novel printing ink:

| | Amount |
|---|---|
| Components | [% by weight] |
| Solvent-containing silver-colored aluminum-based | 20 |
| metal effect pigment paste, average particle | |
| size 10-14 μm, solids: 65%, 35% ethanol | |
| (Aluminum paste Reflexal W 88 n.l., from Eckart,) | |
| Silver-colored mica-based pearl luster pigment | 25 |
| Particle size 10-60 μm (Iriodin ® Pearlets 103, | |
| Sterling White S, from Merck KgaA) | |
| Binder: | 15 |
| Nitrocellulose moistened in ethanol, | |
| solids 65%, 35% of ethanol | |
| Solvents: | 30 |
| ethanol + ethyl acetate | |
| Assistants | |
| PE wax emulsion, 40% of solids, 60% of ethanol | 3 |
| (Lubaprint ® 654D, from Bader) | |
| Monomer plasticizer | 7 |
| Total | 100 |

Experimental procedure: The binder in the ethanol/ethyl acetate mixture and the wax emulsion is introduced into a suitable container and homogenized for 5 minutes. Thereafter, the aluminum paste and then the pearl luster pigment are added in portions and the batch is stirred for a further 30 minutes. If the viscosity is too high, it can be corrected with ethanol or ethyl acetate. Before printing, the ink is stirred for at least 5 minutes for homogenization.

Experiment 5

Pasty metallic printing ink for letterpress printing (gold effect)

The following components were used for formulating the printing ink:

| | Amount |
|---|---|
| Components | [% by weight] |
| Gold-colored metal effect pigment, average | 35 |
| particle size 9 μm (bronze paste rich pale | |
| gold, from Eckart) | |
| Golden mica-based pearl luster pigment | 20 |
| (Iriodin ® Pearlprint Litho Red Gold, | |
| from Merck KgaA) | |
| Binder | 35.6 |
| Modified rosins, boiled with varnish | |
| linseed oil (Lawter binders GV 126 and | |
| LV 4905 in the ratio 1:1) | |
| Varnish linseed oil | 3 |
| Yellow offset printing ink (Yellow of scale | 5 |
| color F1 Drive, BASF Drucksysteme GmbH) | |
| Wax | 1 |
| Drying Agent | 0.4 |
| Manganese octanoate, dissolved in mineral oil | |
| Total | 100 |

Experimental procedure: Binder, varnish linseed oil, the yellow offset printing ink, wax and drying agent are homogenized for 15 minutes using a dissolver. The product is then passed through a suitable three-roll mill. The varnish thus obtained is then slowly stirred, and first the bronze paste and then the pearl luster pigment are added and stirring is continued until the ink is homogeneous.

Comparative Experiment 1

Aqueous metallic flexographic printing ink which contains only one metal effect pigment.

The following components were used for formulating the printing ink:

| | Amount |
|---|---|
| Components | [% by weight] |
| Aqueous brass-based gold bronze paste, average | 33 |
| particle size 10 μm (solids 80% of bronze, | |
| 20% of water) (Gold bronze Aquador ® rich pale | |
| gold, WP 4120/80, from Schlenk) | |
| Binder | 37 |
| Acrylate/styrene dispersion, solids 35%, | |
| water content 65%, | |
| (Zinpol ® 146, from Worl\dot{e}e) | |
| Water | 23 |
| Assistants | |
| PE wax emulsion, 40% of solids, 60% of water | 3 |
| (Lubaprint VP 499, from Bader) | |
| Antifoam based on silicone oil | 0.5 |
| (Tego Foamex ® 3062, from Degussa) | |
| Thickener based on an aqueous polyurethane | 3.5 |
| Solids 75%, water 25% (Borchigel ® L 75 N, | |
| from Bayer AG) | |
| Total | 100 |

Experimental procedure: The binder, together with the water and the assistants (waxes, antifoam, thickener), is introduced into a suitable container and homogenized for 5 minutes. Thereafter, the gold bronze paste is added and the batch is stirred for a further 25 minutes. Finally, the pearl luster pigment is added and stirring is continued for a further 30 minutes. If the viscosity is too high, it can be corrected with water. Before printing, the ink is stirred for at least 5 minutes for homogenization.

Comparative Experiment 2

Metallic gravure or flexographic printing ink comprising organic solvents and containing only one metal effect pigment.

The following components were used for formulating the printing ink:

| | Amount |
|---|---|
| Components | [% by weight] |
| Brass-based gold bronze powder, average | 33 |
| particle size 7-9 μm (Gold bronze | |
| Resist Rotoflex rich pale gold, from Eckart) | |
| Binder | 38 |
| Polyvinyl butyral and aldehyde resin | |
| Solvents: | 26 |
| ethanol, ethyl acetate | |
| Assistants | |
| PE wax emulsion, 40% of solids, 60% of ethanol | 3 |
| (Lubaprint 654D, from Bader) | |
| Total | 100 |

Experimental procedure: The binder in the ethanol/ethyl acetate mixture and the wax emulsion is introduced into a suitable container and homogenized for 5 minutes. Thereafter, the aluminum paste is added in portions and the batch is stirred for a further 30 minutes. If the viscosity is too high, it can be corrected with ethanol or ethyl acetate. Before printing, the ink is stirred for at least 5 minutes for homogenization.

Comparative Experiment 3

Conventional metallic letterpress printing ink according to prior art which contains only one metal effect pigment.

The following components were used for formulating the printing ink:

| | Amount |
|---|---|
| Components | [% by weight] |
| Gold-colored metal effect pigment, average | 50 |
| particle size 9 μm (bronze paste rich | |
| pale gold, from Eckart) | |
| Binder: | 40.6 |
| Based on modified rosins which are boiled | |
| with varnish linseed oil. Lawter binders | |
| GV 126 and LV 4905 in the ratio 1:1 | |
| Varnish linseed oil | 3 |
| Yellow offset printing ink | 5 |
| (yellow of scale color F1 Drive, | |
| BASF Drucksysteme GmbH) | |
| Wax | 1 |
| Drying Agent | 0.4 |
| Manganese octanoate, dissolved in mineral oil | |
| Total | 100 |

Experimental procedure: Binder, varnish linseed oil, the yellow offset printing ink, wax and drying agent are homogenized for 15 minutes using a dissolver. The product is then passed through a suitable three-roll mill. The varnish thus obtained is then slowly stirred and the bronze paste is added and stirring is carried out until the ink is homogeneous.

Printing experiments:

For the test, labels were printed on a printing press of the type CD 102 Duo (Heidelberger Druckmaschinen) by means of the offset technique, and a pattern was then printed on said labels by means of the flexographic printing unit of the press using the printing inks from experiments and comparative experiments. Before use, the printing inks were each resuspended.

The solvent-based inks were printed on a Moser gravure printing press having 4 printing units.

The letterpress printing inks were printed on a Heidelberger Speedmaster 72 by indirect letterpress printing with the aid of a WS 43 letterpress printing plate from BASF Drucksysteme GmbH.

The brilliance and the crispness of the edges of each print were evaluated. The brilliance was assessed visually. In particular, the luster effect was considered here, i.e. the glitter of the assessed printing inks as a function of the angle of view.

The results are summarized in table 1.

Comparative Experiment 4

Conventional Bronzing

For comparison, the labels printed above were furthermore finished not by printing by means of metallic printing ink but by bronzing in a known manner.

For this purpose, the desired pattern was printed on the labels using a commercial underprinting ink of high viscosity and tack. Thereafter, the sheets printed in the sheet-fed offset printing press were removed from the delivery of the printing press via conveyor belts and fed to a commercial bronzing machine.

The evaluation of the bronzed labels was carried out according to the same criteria as above, and the results are likewise contained in table 1.

TABLE 1
Evaluation of the results of experiments
and comparative experiments

| Experiment | Angle | |
|---|---|---|
| number | dependency/Brilliance | Edge crispness |
| Experiment 1 | Angle-independent | Good |
| Gold | gloss 1-2 | |
| Experiment 2 | Angle-independent | Good |
| Silver | gloss 2 | |
| Experiment 3 | Angle-independent | Good |
| Gold | gloss 1-2 | |
| Experiment 4 | Angle-independent | Good |
| Silver | gloss 2 | |
| Experiment 5 | Angle-independent | Very good |
| Gold | gloss 2-3 | |
| Comparative experiment 1 | Gloss very | Good |
| Gold | angle-dependent 2-3 | |
| Comparative experiment 2 | Gloss very | Good |
| Gold | angle-dependent 2-3 | |
| Comparative experiment 3 | Gloss very | Very good |
| Gold | angle-dependent 3 | |
| Comparative experiment 4 | Angle-independent | Poor |
| Gold | gloss 1 | Frayed edge |

(1 = very good, 2 = good, 3 = satisfactory, 4 = adequate, 5 = poor).

The conventional metallic inks according to the comparative experiments, which contain only one metal effect pigment, have a strong angle dependency of the gloss. This means that metallic gloss of the printing ink is not perceptible at certain angles of view. At such an angle, the ink appears dull, tends to have a yellowish beige appearance and exhibits no metallic gloss. The novel metallic inks on the other hand have an angle-independent gloss. In conventional bronzing (comparative experiment 4), an angle-independent gloss is likewise obtained but the edges of the printed motifs are very frayed.

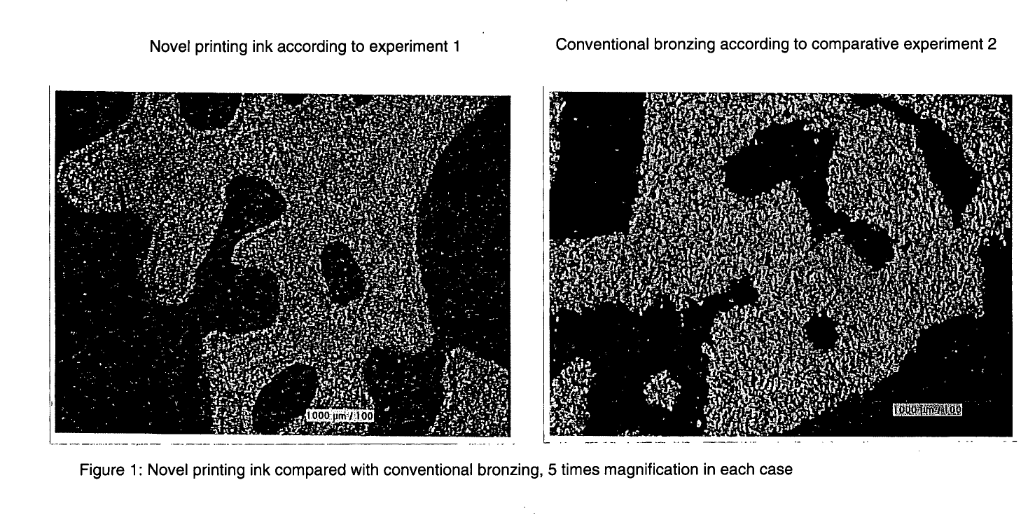

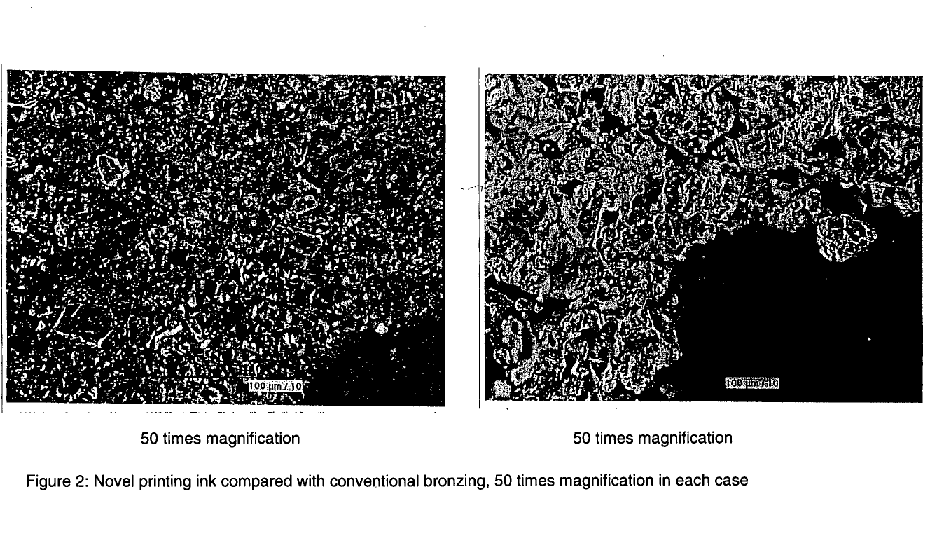

FIGS. 1 and 2 show the prints of experiment 1 and of comparative experiment 4 (conventional bronzing) under 5 times and under 50 times magnification.

Under 50 times magnification, it can be seen that the surface of the layer printed with the novel ink and that of the layer obtained by means of conventional bronzing are very similar. The pigments of the printed layer are not oriented in a preferred direction. Under 5 times magnification, it is very clearly evident that the edges of the printed layer are substantially crisper, whereas the conventional bronzing gives frayed edges.

1. A liquid metallic printing ink for flexographic, gravure or screen printing, at least comprising a solvent or solvent mixture, at least one polymeric binder, at least two different effect pigments and optionally further additives, wherein the effect pigments comprise from 20 to 60% by weight of at least one metal effect pigment and from 20 to 60% by weight of at least one Perl luster pigment consisting of transparent or semitransparent lamellar substrates, selected from the group consisting of mica, synthetic mica, talc, Kaolin and glass which are coated with colorless or colored metal oxides, and/or a partly optically transparent effect pigment based on liquid crystals, with the proviso that the total amount of all effect pigments in the printing ink is from 40 to 80% by weight, the amounts in each case being based on the sum of all components of the printing ink.

2. A metallic printing ink as claimed in claim 1, wherein the total amount of all effect pigments in the printing ink is from 50 to 75% by weight.

3. A metallic printing ink as claimed in claim 1, wherein the total amount of all effect pigments in the printing ink is from 55 to 70% by weight.

4. A metallic printing ink as claimed in claim 1, wherein the amount of metal effect pigments in the printing ink is from 25 to 45% by weight.

5. A metallic printing ink as claimed in claim 1, wherein the amount of the partly optically transparent effect pigments in the printing ink is from 25 to 45% by weight.

6. A metallic printing ink as claimed in claim 1, wherein the solvent or solvent mixture is water or a predominantly aqueous solvent mixture.

7. A pasty metallic printing ink for offset or letterpress printing, at least comprising a solvent or solvent mixture, at least one polymeric binder, at least two different effect pigments and optionally further additives, wherein the effect pigments comprise from 10 to 40% by weight of at least one Perl luster pigment consisting of transparent or semitransparent lamellar substrates, selected from the group consisting of mica, synthetic mica, talc, Kaolin and glass which are coated with colorless or colored metal oxides, and/or a partly optically transparent effect pigment based on liquid crystals and from 8 to 30% by weight of at least one partly optically transparent effect pigment, with the proviso that the total amount of all effect pigments in the printing ink is from 18 to 55% by weight, the amounts in each case being based on the sum of all components of the printing ink.

8. A metallic printing ink as claimed in claim 1, wherein the metal effect pigment is an aluminum-based silver pigment and/or a gold bronze-based gold pigment.

9. A metallic printing ink as claimed in claim 1, wherein the printing ink also comprises further colorants.

10. A metallic printing ink as claimed in claim 1 which is a UV-curable ink.

11. (canceled)

12. A process for finishing prints, in which a one-color or multicolor printing press which is equipped with an additional printing unit for printing with metallic inks is used, a substrate is printed on by means of the printing press and metallic motifs are applied to the printed substrate by means of the additional printing unit and of a metallic printing ink as claimed in claim 1.

13. A process as claimed in claim 12, wherein a protective layer is also applied to the finished print.

14. A process as claimed in claim 12, wherein the printing press is an offset or flexographic printing press.

15. A process as claimed in claim 14, wherein the additional printing unit is a flexographic or gravure printing unit.

16. A printed substrate obtained by a process as claimed in claim 12.
